(19) United States
(12) Patent Application Publication
(10) Pub. No.: US 2025/0219430 A1
(43) Pub. Date: Jul. 3, 2025

(54) INFORMATION PROCESSING DEVICE AND INFORMATION PROCESSING METHOD

(71) Applicant: SONY GROUP CORPORATION, TOKYO (JP)

(72) Inventor: TOSHIMITSU KAI, TOKYO (JP)

(21) Appl. No.: 18/851,883

(22) PCT Filed: Feb. 3, 2023
(86) PCT No.: PCT/JP2023/003614

§ 371 Date: Sep. 27, 2024

(30) Foreign Application Priority Data
Mar. 31, 2022 (JP) 2022-059155

(51) Int. Cl. H02J 7/00; H02J 1/10

(52) U.S. Cl. CPC H02J 7/0047; H02J 1/10

(57) ABSTRACT

To predict the amount of power that can be supplied from a power supply device in which a main power supply and a capacitor are connected in parallel. An information processing device including: a capacitor prediction unit that predicts an amount of current supplied from a capacitor by a latest drive command on the basis of a total amount of current supplied by a previous drive command from a power supply unit including a main power supply and the capacitor connected in parallel, and an amount of current supplied from the capacitor by the previous drive command; and an allowable output prediction unit that predicts an allowable amount of current that is allowed to be supplied from the power supply unit by a next drive command on the basis of a total amount of current supplied from the power supply unit by the latest drive command and the amount of current predicted by the capacitor prediction unit.

### TECHNICAL FIELD

The present disclosure relates to an information processing device and an information processing method.

### BACKGROUND ART

In recent years, power supply devices including a main power supply such as a secondary battery or a fuel cell and a capacitor connected in parallel have been developed in order to cope with an instantaneous increase in power consumption.

For example, Patent Document 1 below discloses a hybrid fuel cell power generation system including a fuel cell and a capacitor connected in parallel. In the fuel cell power generation system disclosed in Patent Document 1, the voltage between the terminals of the capacitor is controlled by a DC-DC converter in the case of a shortage of power supply from the fuel cell, and the amount of the power shortage thereby can be actively extracted from the capacitor. In this way, the fuel cell power generation system disclosed in Patent Document 1 can cause the capacitor to assist the power supply in the case of an instantaneous increase in power consumption or the like.

### CITATION LIST

### Patent Document

Patent Document 1: Japanese Patent Application Laid-Open No. 2005-085623

### SUMMARY OF THE INVENTION

### Problems to be Solved by the Invention

The above-described fuel cell power generation system disclosed in Patent Document 1 is assumed to extract power from the capacitor on a onetime basis in the case of a shortage of power supply from the fuel cell. On the other hand, the discharge capacity of the capacitor varies depending on the past charge/discharge situation. For this reason, in a case where power is frequently extracted from the capacitor, it has been sometimes hard to supply sufficient power from the capacitor in the fuel cell power generation system disclosed in Patent Document 1.

Therefore, the present disclosure proposes a novel and improved information processing device and information processing method for predicting the amount of power that can be supplied from a power supply device by predicting the discharge capacity of a capacitor in the power supply device including a main power supply and the capacitor connected in parallel.

### Solutions to Problems

The present disclosure provides an information processing device including: a capacitor prediction unit that predicts an amount of current supplied from a capacitor by a latest drive command on the basis of a total amount of current supplied by a previous drive command from a power supply unit including a main power supply and the capacitor connected in parallel, and an amount of current supplied from the capacitor by the previous drive command; and an allowable output prediction unit that predicts an allowable amount of current that is allowed to be supplied from the power supply unit by a next drive command on the basis of a total amount of current supplied from the power supply unit by the latest drive command and the amount of current predicted by the capacitor prediction unit.

In addition, the present disclosure provides an information processing method including: predicting, by an arithmetic device, an amount of current supplied from a capacitor by a latest drive command on the basis of a total amount of current supplied by a previous drive command from a power supply unit including a main power supply and the capacitor connected in parallel, and an amount of current supplied from the capacitor by the previous drive command; and predicting, by the arithmetic device, an allowable amount of current that is allowed to be supplied from the power supply unit by a next drive command on the basis of a total amount of current supplied from the power supply unit by the latest drive command and the predicted amount of current supplied from the capacitor.

### BRIEF DESCRIPTION OF DRAWINGS

FIG. 1 is a schematic circuit diagram illustrating the configuration of a power supply unit to which the technology according to the present disclosure is applied.

FIG. 2 is a block diagram illustrating the functional configuration of a control device that realizes the technology according to the present disclosure.

FIG. 3 is a block diagram illustrating functional configurations of a host control device and an intermediate control device that realize the technology according to the present disclosure.

FIG. 4 is a flowchart illustrating an example of the operation of the control device that realizes the technology according to the present disclosure.

### MODE FOR CARRYING OUT THE INVENTION

A preferred embodiment of the present disclosure is hereinafter described in detail with reference to the accompanying drawings. Note that, in the present specification and drawings, components having substantially the same functional configuration are denoted by the same reference signs, and redundant description is omitted.

Note that the description will be given in the following order.
1. Configuration example
   1.1. Configuration of power supply unit
   1.2. Configuration of information processing device
   1.3. Modification
2. Operation example

### 1. Configuration Example

### (1.1. Configuration of Power Supply Unit)

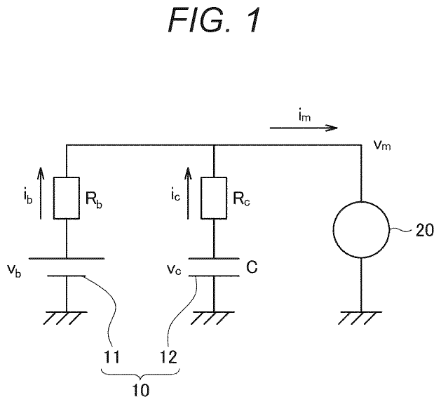

First, the configuration of a power supply unit to which the technology according to the present disclosure is applied will be described with reference to FIG. 1. FIG. 1 is a schematic circuit diagram illustrating the configuration of a power supply unit 10 to which the technology according to the present disclosure is applied.

As illustrated in FIG. 1, the power supply unit 10 includes a main power supply 11 and a capacitor 12 connected in parallel. The power supply unit 10 supplies power from the main power supply 11 and the capacitor 12 to a load 20.

The main power supply 11 is a constant voltage power supply that supplies power mainly to the load 20. The main power supply 11 may be, for example, a battery including a secondary battery that is chargeable and dischargeable. The main power supply 11, for example, can supply a current i_{b} to the load 20 via a resistor R_{b} including internal resistance and wiring resistance by outputting a predetermined voltage v_{b}.

The capacitor 12 is a power storage device that assists the main power supply 11 to supply power to the load 20. The capacitor 12 may be, for example, a capacitor module in which a plurality of electric double layer capacitors is connected in multiple series and multiple parallel. The capacitor 12, for example, can output a current i_{c} to the load 20 via a resistor R_{c} including internal resistance and wiring resistance by outputting a voltage v_{c} corresponding to the amount of stored charge.

A voltage vₘ obtained by subtracting a voltage drop due to the resistor R_{b} from the voltage v_{b} output from the main power supply 11 is applied to the load 20 connected to the power supply unit 10. As a result, a current iₘ obtained by adding the current i_{b} supplied from the main power supply 11 and the current i_{c} supplied from the capacitor 12 is supplied to the load 20.

For example, in a case where temporary peak power consumption occurs in the load 20, the power supply unit 10 can cope with peak power consumption exceeding the output characteristic of the main power supply 11 by supplying power to the load 20 from the capacitor 12 in addition to the main power supply 11. Accordingly, in the power supply unit 10, it is possible to avoid excessively increasing the size of the main power supply 11 or increasing the output characteristic in exchange for decreasing in the capacity characteristic, in order to cope with the peak power consumption of the load 20.

However, in a case where peak power consumption of different magnitudes occurs randomly and frequently in the load 20, the amount of power stored in the capacitor 12 varies, so that the amount of power that can be supplied from the capacitor 12 to the load 20 also varies. Therefore, in a case where the amount of power that can be supplied from the capacitor 12 is insufficient for peak power consumption, there is a possibility that the power supply unit 10 running short of capacitance is instantaneously interrupted.

The technology according to the present disclosure has been conceived in view of the above-described circumstances. The technology according to the present disclosure is a technology for predicting the amount of current supplied from the capacitor 12 by the latest drive command on the basis of the total amount of current supplied from the power supply unit 10 by the previous drive command and the amount of current supplied from the capacitor 12 by the previous drive command. Accordingly, the technology according to the present disclosure can predict the allowable amount of current that can be output from the power supply unit 10 by the next drive command on the basis of the total amount of current supplied from the power supply unit 10 by the latest drive command and the amount of current supplied from the capacitor 12 by the latest drive command.

Note that the load 20 in which peak power consumption of different magnitudes occurs randomly and frequently can be exemplified by a motor that drives a leg of a legged mobile body or a motor that drives an arm of an articulated manipulator device. The motor provided at a joint of the leg or arm of these robot devices is intermittently driven in accordance with the motion of the leg or arm, thus causing peak power consumption of different magnitudes frequently. The technology according to the present disclosure can be suitably used for a control device that controls the driving of these motors.

### (1.2. Configuration of Information Processing Device)

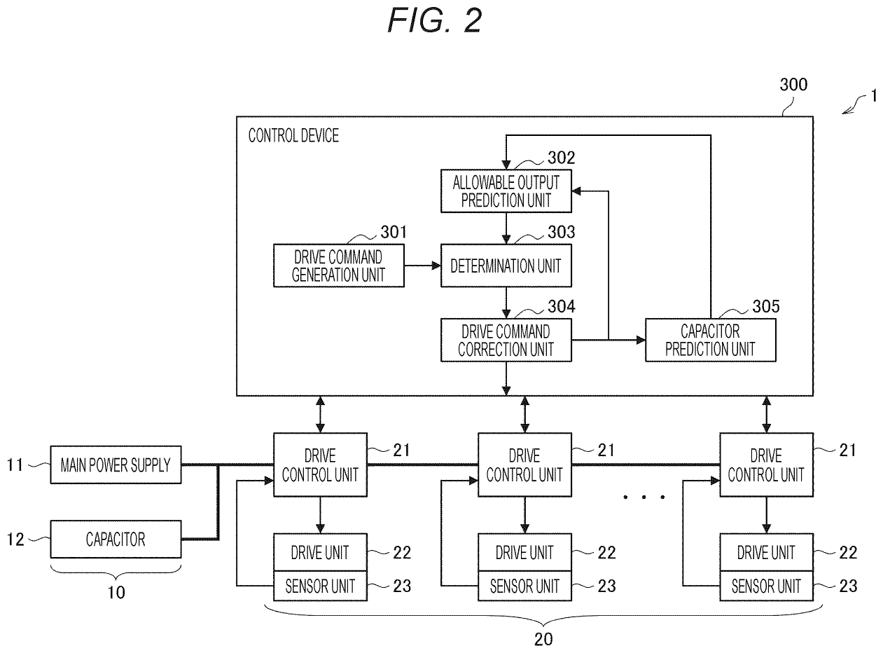

Next, the configuration of an information processing device that realizes the technology according to the present disclosure will be described with reference to FIG. 2. FIG. 2 is a block diagram illustrating the functional configuration of a control device 300 that controls a robot device 1 including the power supply unit 10 and the load 20. The control device 300 is an embodied example of an information processing device that realizes the technology according to the present disclosure.

As illustrated in FIG. 2, the control device 300 generates a drive command for the load 20 and predicts the amount of current that can be supplied from the power supply unit 10 to the load 20. This enables the control device 300 to correct the drive command for the load 20 on the basis of the predicted amount of current that can be supplied, such that the amount of current consumed by the load 20 does not exceed the amount of current that can be supplied.

The power supply unit 10 is a power supply device including the main power supply 11, such as a secondary battery, and the capacitor 12 connected in parallel as described above. The power supply unit 10 can supply power to the load 20 including a plurality of drive units 22.

The load 20 includes the plurality of drive units 22, a plurality of drive control units 21 that controls the driving of the plurality of drive units 22, respectively, and a plurality of sensor units 23 that senses the driving of the plurality of drive units 22, respectively.

The drive control units 21 are microcontrollers or microprocessors that control the drive units 22 in order to execute a drive command output from the control device 300. The drive units 22 are electric motors such as motors. The drive units 22 may be, for example, motors that operate each joint of the robot device 1. The sensor units 23 are, for example, encoders provided in the drive units 22 in order to detect the rotational positions and the rotational speeds of the drive units 22. This enables the drive control units 21 to control the driving of the drive units 22 according to a drive command on the basis of the rotational positions and the rotational speeds of the drive units 22 sensed by the sensor units 23.

The control device 300 includes a drive command generation unit 301, a capacitor prediction unit 305, an allowable output prediction unit 302, a determination unit 303, and a drive command correction unit 304.

The drive command generation unit 301 generates drive commands for the drive units 22 of the robot device 1, respectively, on the basis of the sensing result of the external environment of the robot device 1 and the sensing result of the posture of the robot device 1 (for example, the respective sensing results of the sensor units 23). The drive command generation unit 301 may periodically generate the drive commands at predetermined time intervals (for example, 1 m/s intervals). The drive commands generated by the drive command generation unit 301 are output to the drive control units 21, respectively, after the determination unit 303 determines that the amount of current consumed by the drive units 22 to execute the drive commands does not exceed the amount of current that can be output from the power supply unit 10.

The capacitor prediction unit 305 predicts the amount of current supplied from the capacitor 12 by the latest drive command on the basis of the amount of current supplied from the power supply unit 10 and the capacitor 12 by a past drive command. Specifically, the capacitor prediction unit 305 can recursively predict the amount of current supplied from the capacitor 12 by the latest drive command, on the basis of the amount of current supplied from the power supply unit 10 and the capacitor 12 by the previous drive command and the amount of current supplied from the power supply unit 10 by the latest drive command.

For example, the circuit equations of the circuit including the power supply unit 10, in which the main power supply 11 and the capacitor 12 are connected in parallel, and the load 20 (circuit illustrated in FIG. 1) are expressed as Equations 1 to 4 below.

$$[ Mathematical formula 1 ]$$

$${i}_{m} ( t ) = {i}_{b} ( t ) + {i}_{c} ( t ) \qquad Equation 1$$

$${v}_{b} = {i}_{b} ( t ) {R}_{b} + {v}_{m} ( t ) \qquad Equation 2$$

$${v}_{c} ( t ) = {i}_{c} ( t ) {R}_{c} + {v}_{m} ( t ) \qquad Equation 3$$

$${v}_{c} ( t ) = \frac{1}{c} \int - {i}_{c} ( t ) dt \qquad Equation 4$$

iₘ(t): Total current to load 20
vₘ(t): Total voltage to load 20
iₕ(t): Discharge current of main power supply 11
v_{b}: Output voltage of main power supply 11
R_{b}: Internal resistance of main power supply 11
i_{c}(t): Discharge current of capacitor 12
v_{c}(t): Output voltage of capacitor 12
R_{c}: Equivalent series resistance of capacitor 12
C: Capacitance of capacitor 12

Note that v_{b}, R_{b}, R_{c}, and C are constants. The amount of variation of the output voltage v_{b} of the main power supply 11 is extremely small, compared to that of the output voltage v_{c}(t) of the capacitor 12, and thus can be regarded as a constant.

Equations 1 to 4 above are combined into Equation 5 below. Furthermore, with Equation 5 solved, the amount i_{c} (t) of current supplied from the capacitor 12 can be expressed as Equation 6 below.

$$[ Mathematical formula 2 ]$$

$$\int {i}_{c} ( t ) dt + {i}_{c} ( t ) C ( {R}_{b} + {R}_{c} ) - {i}_{m} ( t ) {CR}_{b} + {Cv}_{b} = 0 \qquad Equation 5$$

$${i}_{c} ( t ) = \frac{{R}_{b}}{{R}_{b} + {R}_{c}} {i}_{m} ( t ) - \frac{{R}_{b}}{{C ( {R}_{b} + {R}_{c} )}^{2}} {\int }_{0}^{t} {e}^{- \frac{1}{C ( {R}_{b} + {R}_{c} )} τ} {i}_{m} ( t - τ ) d τ - \frac{1}{{R}_{b} + {R}_{c}} ( \frac{q ( 0 )}{C} + {v}_{b} ) {e}^{- \frac{1}{C ( {R}_{b} + {R}_{c} )} t} \qquad Equation 6$$

Here, history information of the total amount of current to the load 20 from time 0 to time t is required in order to perform the calculation of a convolution integral in Equation 6. However, it is not realistic to keep holding the history information of the total amount of current to the load 20 from time 0 at all times, because an enormous memory is required as the operation time of the robot device 1 becomes longer. In the present embodiment, the amount i_{c} (t) of current supplied from the capacitor 12 can be derived with simpler calculation by approximating Equation 6 to the expression of a recurrence formula.

Specifically, Equation 5 at time t=t₁ is expressed as Equation 7 below, and Equation 5 at time t=t₁+Δt is expressed as Equation 8 below, where Δt is a time interval (step width) at which a drive command is generated.

$$[ Mathematical formula 3 ]$$

$${\int }_{- ∞}^{{t}_{1}} {i}_{c} ( t ) dt + {i}_{c} ( {t}_{1} ) C ( {R}_{b} + {R}_{c} ) - {i}_{m} ( {t}_{1} ) {CR}_{b} + {Cv}_{b} = {\int }_{- ∞}^{0} {i}_{c} ( t ) dt + {\int }_{0}^{Δ t} {i}_{c} ( t ) dt + {\int }_{Δ t}^{2 Δ t} {i}_{c} ( t ) dt + … + {\int }_{{t}_{1} - Δ t}^{{t}_{1}} {i}_{c} ( t ) dt + {i}_{c} ( {t}_{1} ) C ( {R}_{b} + {R}_{c} ) + {i}_{m} ( {t}_{1} ) {CR}_{b} - {Cv}_{b} = 0 \qquad Equation 7$$

$${\int }_{- ∞}^{{t}_{1} + Δ t} {i}_{c} ( t ) dt + {i}_{c} ( {t}_{1} + Δ t ) C ( {R}_{b} + {R}_{c} ) - {i}_{m} ( {t}_{1} + Δ t ) {CR}_{b} + {Cv}_{b} = {\int }_{- ∞}^{0} {i}_{c} ( t ) dt + {\int }_{0}^{Δ t} {i}_{c} ( t ) dt + {\int }_{Δ t}^{2 Δ t} {i}_{c} ( t ) dt + \text{} … + {\int }_{{t}_{1} - Δ t}^{{t}_{1}} {i}_{c} ( t ) dt + {\int }_{{t}_{1}}^{{t}_{1} + Δ t} {i}_{c} ( t ) dt + {i}_{c} ( {t}_{1} + Δ t ) C ( {R}_{b} + {R}_{c} ) + {i}_{m} ( {t}_{1} + Δ t ) {CR}_{b} - {Cv}_{b} = 0 \qquad Equation 8$$

Equation 9 below is obtained by subtracting Equation 7 from Equation 8.

$$[ Mathematical formula 4 ]$$

$${\int }_{{t}_{1}}^{{t}_{1} + Δ t} {i}_{c} ( t ) dt + C ( {R}_{b} + {R}_{c} ) ( {i}_{c} ( {t}_{1} + Δ t ) - {i}_{c} ( {t}_{1} ) ) - {CR}_{b} ( {i}_{m} ( {t}_{1} + Δ t ) - {i}_{m} ( {t}_{1} ) ) = 0 \qquad Equation 9$$

Equation 9 is arranged as in Equation 11 below through the trapezoidal approximation of the integral terms from t₁ to t₁+Δt in Equation 9 as in Equation 10 below.

$$[ Mathematical formula 5 ]$$

$${\int }_{{t}_{1}}^{{t}_{1} + Δ t} {i}_{c} ( t ) dt \approx \frac{1}{2} Δ t ( {i}_{c} ( {t}_{1} + Δ t ) + {i}_{c} ( {t}_{1} ) ) \qquad Equation 10$$

$${i}_{c} ( {t}_{1} + Δ t ) = \frac{2 C ( {R}_{b} + {R}_{c} ) - Δ t}{2 C ( {R}_{b} + {R}_{c} ) + Δ t} {i}_{c} ( {t}_{1} ) + \frac{2 {CR}_{b}}{2 C ( {R}_{b} + {R}_{c} ) + Δ t} ( {i}_{m} ( {t}_{1} + Δ t ) - {i}_{m} ( {t}_{1} ) ) \qquad Equation 11$$

Furthermore, Equation 12, which is a recurrence formula, is obtained by replacing the time t₁ with time t.

$$[ Mathematical formula 6 ]$$

$${i}_{c} ( t + Δ t ) = f ( {i}_{c} ( t ) , {i}_{m} ( t ) , {i}_{m} ( t + Δ t ) ) = \frac{2 C ( {R}_{b} + {R}_{c} ) - Δ t}{2 C ( {R}_{b} + {R}_{c} ) + Δ t} {i}_{c} ( t ) + \frac{2 {CR}_{b}}{2 C ( {R}_{b} + {R}_{c} ) + Δ t} ( {i}_{m} ( t + Δ t ) - {i}_{m} ( t ) ) \qquad Equation 12$$

In this way, the capacitor prediction unit 305 can recursively predict the amount of current supplied from the capacitor 12 at time t+Δt by performing the sequential calculation of Equation 12 above, even without holding the history information of the total amount of current to the load 20 from time 0 to time t. That is, the capacitor prediction unit 305 can recursively predict the amount i_{c} (t+Δt) of current supplied from the capacitor 12 by the latest drive command on the basis of the amounts iₘ (t) and i_{c} (t) of current supplied from the power supply unit 10 and the capacitor 12 by the previous drive command and the amount iₘ (t+Δt) of current supplied from the power supply unit 10 by the latest drive command.

The amounts iₘ (t) and iₘ (t+Δt) of current supplied from the power supply unit 10 and the amount i_{c} (t) of current supplied from the capacitor 12 may not be actually measured values. For example, the amount iₘ (t) of current and the amount iₘ (t+Δt) of current supplied from the power supply unit 10 may be estimated values or command values according to a drive command. Similarly, the amount i_{c} (t) of current supplied from the capacitor 12 may be an estimated value. In a case where estimated values or command values other than actually measured values are used to predict the amount of current supplied from the capacitor 12, the robot device 1 does not need to actually measure each of the amounts of current. It is therefore possible to reduce the mounting cost of a sensor that measures each of the amounts of current.

Note that the above-described prediction of the amount of current supplied from the capacitor 12 includes an estimation error. In addition, since there is no feedback mechanism in the prediction by the capacitor prediction unit 305, it is conceivable that estimation errors are gradually accumulated by repeating recursive prediction. However, the prediction of the amount of current supplied from the capacitor 12 is largely influenced by the amount of current supplied from the power supply unit 10 and the capacitor 12 by the previous drive command, and the influence of the amount of current supplied from the power supply unit 10 and the capacitor 12 by the drive commands before the previous drive command exponentially decreases. Accordingly, the influence on actual practice is considered to be negligible, although the past estimation errors are accumulated in the prediction by the capacitor prediction unit 305.

Furthermore, in a state where the variation of the amount of current is small, the estimation error in the amount of current supplied from the power supply unit 10 and the capacitor 12 is extremely small. Therefore, the robot device 1 can improve the accuracy of the prediction by the capacitor prediction unit 305 on a onetime basis by providing a period in which the variation of the amount of current is small and temporarily reducing the influence of the estimation error on the prediction the capacitor prediction unit 305 immediately after the period.

The allowable output prediction unit 302 dynamically predicts the allowable amount of current that can be supplied from the power supply unit 10 by the next drive command on the basis of the total amount of current supplied from the power supply unit 10 by the latest drive command and the amount of current predicted by the capacitor prediction unit 305. Specifically, the allowable output prediction unit 302 can predict the allowable amount of current that can be supplied from the power supply unit 10 by the next drive command on the basis of the amount of current supplied from the capacitor 12 by the latest drive command predicted by the capacitor prediction unit 305 and the total amount of current supplied from the power supply unit 10 by the latest drive command.

For example, the allowable amount of current that can be supplied from the power supply unit 10 at time t is defined as i_{m_limit} (t). As described above in the explanation of the capacitor prediction unit 305, iₘ (t) is the sum of i_{b}(t) and i_{c} (t). Thus, if the maximum value of the amount of current that can be supplied from the main power supply 11 is defined as I_{battmax}, the relationship of Inequality 21 below holds for iₘ (t), i_{b} (t), i_{c} (t), and I_{battmax}.

$$[ Mathematical formula 7 ]$$

$${i}_{m} ( t ) - {i}_{c} ( t ) < {I}_{battmax} \qquad Inequality 21$$

Since the relationship of Inequality 21 holds at time t+Δt as well, Inequality 22 below is obtained by replacing time t with time t+Δt, then substituting Equation 12 into Inequality 21, and arranging the inequality.

$$[ Mathematical formula 8 ]$$

$${i}_{m} ( t + Δ t ) < \frac{2 C ( {R}_{b} + {R}_{c} ) + Δ t}{2 {CR}_{c} + Δ t} {I}_{battmax} - \frac{2 {CR}_{b}}{2 {CR}_{c} + Δ t} {i}_{m} ( t ) + \frac{2 C ( {R}_{b} + {R}_{c} ) - Δ t}{2 {CR}_{c} + Δ t} {i}_{c} ( t ) \qquad Inequality 22$$

That is, the right side of Inequality 22 is the allowable amount i_{m_limit} (t+Δt) of current that can be supplied from the power supply unit 10 at time t+Δt. Accordingly, the allowable output prediction unit 302 can predict the allowable amount i_{m_limit} (t+Δt) of current that can be supplied from the power supply unit 10 at time t+Δt by performing the calculation of Inequality 22 above. Here, the maximum value I_{battmax} of the amount of current that can be supplied from the main power supply 11 is a constant. Therefore, the allowable output prediction unit 302 can recursively predict the allowable amount i_{m_limit} (t+Δt) of current that can be supplied from the power supply unit 10 by the next drive command on the basis of the amounts iₘ (t) and i_{c} (t) of current supplied from the power supply unit 10 and the capacitor 12 by the latest drive command.

The amount iₘ (t) of current supplied from the power supply unit 10 and the amount i_{c} (t) of current supplied from the capacitor 12 may not be actually measured values. For example, the amount iₘ (t) of current supplied from the power supply unit 10 may be an estimated value or a command value according to a drive command. Similarly, the amount i_{c} (t) of current supplied from the capacitor 12 may be an estimated value. In a case where estimated values or command values other than actually measured values are used to predict the allowable amount of current that can be supplied from the power supply unit 10, the robot device 1 does not need to actually measure each of the amounts of current. It is therefore possible to reduce the mounting cost of a sensor that measures each of the amounts of current.

The determination unit 303 determines whether or not the total amount of current to be supplied from the power supply unit 10 by the next drive command exceeds the allowable amount of current. Specifically, the determination unit 303 determines whether or not the total amount of current to be consumed by each of the drive units 22 to execute the next drive command generated by the drive command generation unit 301 exceeds the allowable amount of current predicted by the allowable output prediction unit 302.

In a case where it is determined that the total amount of current to be consumed by each of the drive units 22 to execute the next drive command exceeds the allowable amount of current that can be supplied from the power supply unit 10, the drive command correction unit 304 corrects the next drive command. Specifically, the drive command correction unit 304 corrects the next drive command such that the total amount of current to be consumed by each of the drive units 22 to execute the next drive command becomes less than equal to the allowable amount of current that can be supplied from the power supply unit 10. For example, the drive command correction unit 304 may reduce the driving amount of each of the drive units 22 by the next drive command or may reduce the number of drive units 22 driven by the next drive command so as to reduce the amount of current to be consumed by the next drive command.

This enables the control device 300 to prevent the total amount of current to be consumed to be consumed by each of the drive units 22 to execute the next drive command from exceeding the allowable amount of current, and instantaneous interruption from occurring due to the capacitance shortage of the power supply unit 10.

As described above, the control device 300 according to the present embodiment can dynamically predict the amount of current that can be supplied from the power supply unit 10 including the capacitor 12 to the load 20, and thus can more efficiently utilize the power resources of the power supply unit 10.

### (1.3. Modification)

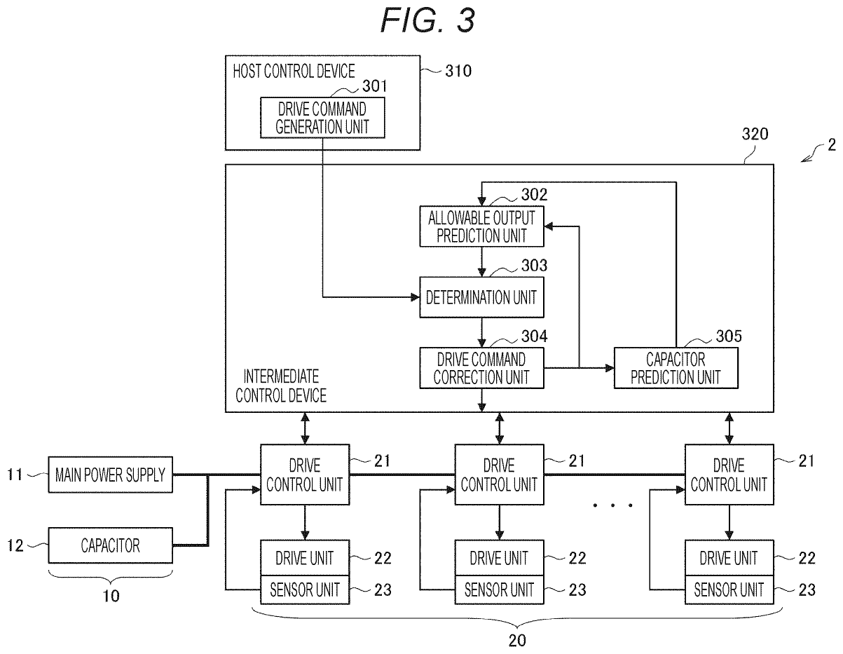

Next, a modification of the present embodiment will be described with reference to FIG. 3. FIG. 3 is a block diagram illustrating the functional configurations of a host control device 310 and an intermediate control device 320 that control a robot device 2 including the power supply unit 10 and the load 20. The intermediate control device 320 is an embodied example of an information processing device that realizes the technology according to the present disclosure.

As illustrated in FIG. 3, in the robot device 2, the functions of the control device 300 in the robot device 1 are implemented separately in the host control device 310 and the intermediate control device 320. Specifically, the function of the drive command generation unit 301 is implemented in the host control device 310, and the functions of the capacitor prediction unit 305, the allowable output prediction unit 302, the determination unit 303, and the drive command correction unit 304 are implemented in the intermediate control device 320. This enables the robot device 2 to output a drive command from a control block close to the drive control units 21 and the drive units 22, so that each of the drive units 22 can be more easily synchronized.

The host control device 310 is, for example, a central processing unit that integrally controls the overall operation of the robot device 2. The function of the drive command generation unit 301 may be implemented in, for example, software executed by a central processing unit (CPU) constituting the host control device 310.

The intermediate control device 320 is, for example, a control device that controls the driving of each joint of an arm or a leg of the robot device 2 in conjunction with each other. The functions of the capacitor prediction unit 305, the allowable output prediction unit 302, the determination unit 303, and the drive command correction unit 304 may be implemented in, for example, hardware of a field-programmable gate array (FPGA) constituting the intermediate control device 320. The capacitor prediction unit 305, the allowable output prediction unit 302, the determination unit 303, and the drive command correction unit 304 do not include complicated arithmetic processing, and thus can be directly implemented in hardware such as an FPGA.

According to the present modification, the robot device 2 can cause the control block close to the drive control units 21 and the drive units 22 to predict the amount of current that can be supplied from the power supply unit 10 and to correct a drive command. Therefore, the robot device 2 can predict the amount of current and correct a drive command more quickly and accurately, and thus can more efficiently utilize the power resources of the power supply unit 10.

### 2. Operation Example

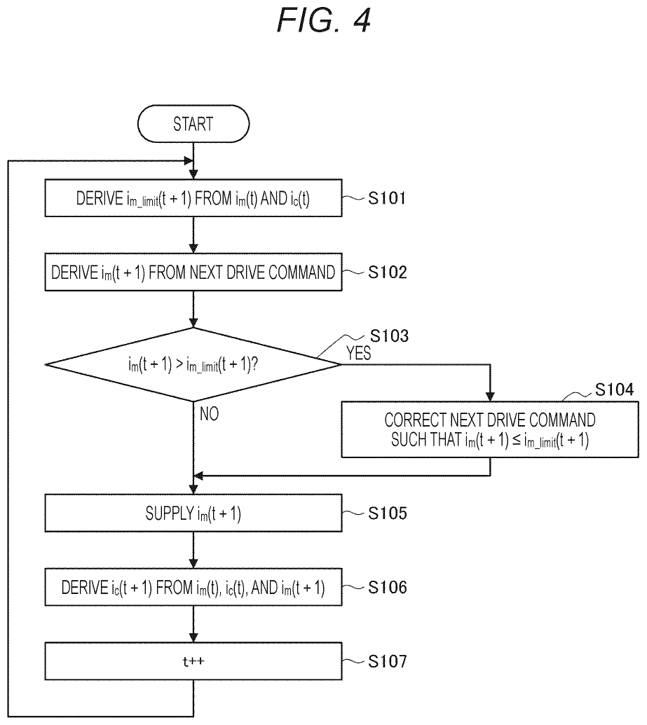

Furthermore, the flow of the operation of the control device 300 according to the present embodiment will be described with reference to FIG. 4. FIG. 4 is a flowchart illustrating an example of the operation of the control device 300 according to the present embodiment.

As illustrated in FIG. 4, first, the allowable output prediction unit 302 predicts the allowable amount i_{m_limit} (t+1) of current on the basis of the amount i_{c} (t) of current supplied from the capacitor 12 by the latest drive command and the amount iₘ (t) of current supplied from the power supply unit 10 by the latest drive command (S101).

Next, the drive command generation unit 301 generates the next drive command. The determination unit 303 derives the amount iₘ (t+1) of current to be consumed by each of the drive units 22 to execute the generated next drive command (S102), and determines whether or not the amount iₘ (t+1) of current exceeds the allowable amount i_{m_limit} (t+1) of current (S103).

In a case where it is determined that the amount iₘ (t+1) of current exceeds the allowable amount i_{m_limit} (t+1) of current (Yes in S103), the drive command correction unit 304 corrects the next drive command such that the amount iₘ (t+1) of current becomes less than or equal to the allowable amount i_{m_limit} (t+1) of current (S104). Then, the drive command that has been corrected such that the amount iₘ (t+1) of current becomes less than or equal to the allowable amount i_{m_limit} (t+1) of current is output to each of the drive control units 21, and the power of the amount iₘ (t+1) of current is supplied from the power supply unit 10 to each of the drive units 22 (S105).

Next, the capacitor prediction unit 305 recursively predicts the amount i_{c} (t+1) of current supplied from the capacitor 12 by the latest drive command on the basis of the amounts iₘ (t) and i_{c} (t) of current supplied from the power supply unit 10 and the capacitor 12 by the previous drive command and the amount iₘ (t+1) of current supplied from the power supply unit 10 by the latest drive command (S106). Then, the control device 300 increases (that is, increments) time t by one, and returns to step S101 to resume the operation.

According to the above-described operation, the control device 300 can recursively predict the amount of current supplied from the capacitor 12 and the amount of current that can be supplied from the power supply unit 10 by alternately repeating the prediction by the allowable output prediction unit 302 and the prediction by the capacitor prediction unit 305. Accordingly, the control device 300 can predict the amount of current supplied from the capacitor 12 without having a memory that holds enormous history information of the total amount of current to the load 20 from time 0 to time t. Therefore, the control device 300 can predict the amount of current that can be supplied from the power supply unit 10 when executing the next drive command.

The preferred embodiments of the present disclosure have been described above in detail with reference to the accompanying drawings, but the technical scope of the present disclosure is not limited to such examples. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to the effect described above or instead of the effect described above.

Note that the following configurations also fall within the technological scope of the present disclosure.

(1)

An information processing device including:
a capacitor prediction unit that predicts an amount of current supplied from a capacitor by a latest drive command on the basis of a total amount of current supplied by a previous drive command from a power supply unit including a main power supply and the capacitor connected in parallel, and an amount of current supplied from the capacitor by the previous drive command; and
an allowable output prediction unit that predicts an allowable amount of current that is allowed to be supplied from the power supply unit by a next drive command on the basis of a total amount of current supplied from the power supply unit by the latest drive command and the amount of current predicted by the capacitor prediction unit.
   (2)

The information processing device according to (1), in which the total amount of current supplied from the power supply unit is an estimated value or a command value according to the drive commands.

(3)

The information processing device according to (1) or (2), in which the amount of current supplied from the capacitor is an estimated value.

(4)

The information processing device according to any one of (1) to (3), in which the capacitor prediction unit is configured to recursively predict the amount of current supplied from the capacitor by the latest drive command on the basis of the total amount of current supplied from the power supply unit by the previous drive command, the amount of current supplied from the capacitor by the previous drive command, and the total amount of current supplied from the power supply unit by the latest drive command.

(5)

The information processing device according to (4), in which the allowable output prediction unit is configured to predict the allowable amount of current that is allowed to be supplied from the power supply unit by the next drive command on the basis of the amount of current supplied from the capacitor by the latest drive command, which is predicted by the capacitor prediction unit, and the total amount of current supplied from the power supply unit by the latest drive command.

(6)

The information processing device according to any one of (1) to (5), further including a drive command correction unit that corrects the next drive command such that a total amount of current to be output from the power supply unit by the next drive command becomes less than or equal to the allowable amount of current, in a case where the total amount of current to be output from the power supply unit by the next drive command exceeds the allowable amount of current.

(7)

The information processing device according to any one of (1) to (6), in which the drive commands are periodically issued at predetermined time intervals.

(8)

The information processing device according to any one of (1) to (7), in which the main power supply is a constant voltage power supply.

(9)

The information processing device according to (8), in which the main power supply is a secondary battery.

(10)

The information processing device according to any one of (1) to (9), in which a current supplied from the power supply unit is input to a load in which peak power consumption of different magnitudes occurs randomly.

(11)

The information processing device according to (10), in which the load includes a motor that operates a joint of an arm or a leg of a robot device.

(12)

The information processing device according to any one of (1) to (11), in which the information processing device is implemented in hardware.

(13)

An information processing method including:
predicting, by an arithmetic device, an amount of current supplied from a capacitor by a latest drive command on the basis of a total amount of current supplied by a previous drive command from a power supply unit including a main power supply and the capacitor connected in parallel, and an amount of current supplied from the capacitor by the previous drive command; and
predicting, by the arithmetic device, an allowable amount of current that is allowed to be supplied from the power supply unit by a next drive command on the basis of a total amount of current supplied from the power supply unit by the latest drive command and the predicted amount of current supplied from the capacitor.

### REFERENCE SIGNS LIST

1, 2 Robot device
10 Power supply unit
11 Main power supply
12 Capacitor
20 Load
21 Drive control unit
22 Drive unit
23 Sensor unit
300 Control device
301 Drive command generation unit
302 Allowable output prediction unit
303 Determination unit
304 Drive command correction unit
305 Capacitor prediction unit
310 Host control device
320 Intermediate control device

1. An information processing device comprising:
a capacitor prediction unit that predicts an amount of current supplied from a capacitor by a latest drive command on a basis of a total amount of current supplied by a previous drive command from a power supply unit including a main power supply and the capacitor connected in parallel, and an amount of current supplied from the capacitor by the previous drive command; and
an allowable output prediction unit that predicts an allowable amount of current that is allowed to be supplied from the power supply unit by a next drive command on a basis of a total amount of current supplied from the power supply unit by the latest drive command and the amount of current predicted by the capacitor prediction unit.

2. The information processing device according to claim 1, wherein the total amount of current supplied from the power supply unit is an estimated value or a command value according to the drive commands.

3. The information processing device according to claim 1, wherein the amounts of current supplied from the capacitor are estimated values.

4. The information processing device according to claim 1, wherein the capacitor prediction unit is configured to recursively predict the amount of current supplied from the capacitor by the latest drive command on a basis of the total amount of current supplied from the power supply unit by the previous drive command, the amount of current supplied from the capacitor by the previous drive command, and the total amount of current supplied from the power supply unit by the latest drive command.

5. The information processing device according to claim 4, wherein the allowable output prediction unit is configured to predict the allowable amount of current that is allowed to be supplied from the power supply unit by the next drive command on a basis of the amount of current supplied from the capacitor by the latest drive command, which is predicted by the capacitor prediction unit, and the total amount of current supplied from the power supply unit by the latest drive command.

6. The information processing device according to claim 1, further comprising a drive command correction unit that corrects the next drive command such that a total amount of current to be output from the power supply unit by the next drive command becomes less than or equal to the allowable amount of current, in a case where the total amount of current to be output from the power supply unit by the next drive command exceeds the allowable amount of current.

7. The information processing device according to claim 1, wherein the drive commands are periodically issued at predetermined time intervals.

8. The information processing device according to claim 1, wherein the main power supply is a constant voltage power supply.

9. The information processing device according to claim 8, wherein the main power supply is a secondary battery.

10. The information processing device according to claim 1, wherein a current supplied from the power supply unit is input to a load in which peak power consumption of different magnitudes occurs randomly.

11. The information processing device according to claim 10, wherein the load includes a motor that operates a joint of an arm or a leg of a robot device.

12. The information processing device according to claim 1, wherein the information processing device is implemented in hardware.

13. An information processing method comprising:
predicting, by an arithmetic device, an amount of current supplied from a capacitor by a latest drive command on a basis of a total amount of current supplied by a previous drive command from a power supply unit including a main power supply and the capacitor connected in parallel, and an amount of current supplied from the capacitor by the previous drive command; and
predicting, by the arithmetic device, an allowable amount of current that is allowed to be supplied from the power supply unit by a next drive command on a basis of a total amount of current supplied from the power supply unit by the latest drive command and the predicted amount of current supplied from the capacitor.
